(19) United States
(12) Patent Application Publication
(10) Pub. No.: US 2025/0251696 A1
(43) Pub. Date: Aug. 7, 2025

(54) IMAGE FORMING APPARATUS

(71) Applicant: CANON KABUSHIKI KAISHA, Tokyo (JP)

(72) Inventor: KAZUKI TAKASE, Shizuoka (JP)

(21) Appl. No.: 19/044,001

(22) Filed: Feb. 3, 2025

(30) Foreign Application Priority Data
Feb. 5, 2024 (JP) 2024-015859

(51) Int. Cl. G03G 21/18

(52) U.S. Cl. CPC G03G 21/1857

(57) ABSTRACT

A first gear includes a gear member and a spacer provided inside the gear member with respect to a direction that is perpendicular to an axial direction, and the first gear is rotatably supported by a shaft member by having the spacer slidably come into contact with the shaft member. As a retaining structure, the gear member and the spacer include a snap-fit and a first engaging portion that engages with the snap-fit, and, as a rotation-preventing structure, include a slit and a second engaging portion that engages with the slit. In the first gear, a range, in the axial direction, of a portion provided with the retaining structure and a range, in the axial direction, of a portion provided with the rotation-preventing structure at least partially overlap with each other in the axial direction.

### BACKGROUND

### Field

The present disclosure relates to an image forming apparatus.

### Description of the Related Art

Image forming apparatuses that form a toner image on a recording material by using an electrophotographic process include an image forming apparatus in which process members used for image formation such as a photosensitive drum are collectively assembled into a cartridge that can be attached to and detached from an apparatus main body. Such an image forming apparatus is configured such that a driving force is transmitted from a driving source of the apparatus main body to a driven member included in the cartridge via a drive transmitting gear.

A configuration is known in which, in a case where a gear has a relatively large diameter, a hole is provided in the gear coaxially to a shaft member supporting the gear, a reinforcement member is inserted in the hole, the reinforcement member is brought into contact with the shaft member to be directly supported by the shaft member, and the gear is indirectly supported by the shaft member via the reinforcement member (FIG. 53 in Japanese Patent Application Laid-open No. 2022-041975). By adopting such a configuration, when the gear with a relatively large diameter is made of a single resin-molded member, a decline in gear molding accuracy due to sink marks can be suppressed and a decline in strength can also be suppressed since there is no longer a need to provide a thinned shape.

In addition, constructing a locking structure of a sensor magnet using a plurality of snap-fits for mounting the sensor magnet to a motor shaft is known (Japanese Patent No. 5457091).

### SUMMARY

Some embodiments of the present disclosure suppress the relative movement of two members that constitute a gear that transmits a driving force to a driven member of an image forming apparatus with a compact structure.

One aspect of the present disclosure is an image forming apparatus, including: a shaft member; a first gear configured to receive a driving force from a driving source, the first gear being supported by the shaft member so as to be rotatable around a rotational axis extending in an axial direction of the shaft member; a second gear configured to mesh with the first gear, the second gear being rotatable by the driving force transmitted from the first gear; and a driven member that is driven by the driving force transmitted to the second gear, wherein the first gear includes: a first member that is provided with gear teeth, the gear teeth of the first member being configured to mesh with teeth of the second gear; a second member, which is provided inside the first member with respect to a direction orthogonal to the axial direction and which is rotatably supported by the shaft member, and provided with (i) a contact portion that comes into contact with an inner circumferential surface of the first member, (ii) an inner circumferential surface slidably coming into contact with an outer circumferential surface of the shaft member; a first restricting structure including a first engaging portion and a first engaged portion that is configured to be engaged with the first engaging portion, the first restricting structure restricting a relative movement, in the axial direction, of the second member relative to the first member; and a second restricting structure including a second engaging portion and a second engaged portion that is configured to be engaged with the second engaging portion, the second restricting structure restricting a relative movement, in a circumferential direction of the shaft member, of the second member relative to the first member, and wherein, in the first gear, a first range and a second range at least partially overlap with each other with respect to the axial direction, where the first range is a range, in the axial direction, of a portion that is provided with the first restricting structure, and the second range is a range, in the axial direction, of a portion that is provided with the second restricting structure.

Further features of various embodiments of the present disclosure will become apparent from the following description of exemplary embodiments with reference to the attached drawings.

### BRIEF DESCRIPTION OF THE DRAWINGS

FIG. 1 is a sectional view of an image forming apparatus according to a first embodiment.

FIG. 2 is a perspective view of a vicinity of a drum gear of a process cartridge according to the first embodiment.

FIG. 3A is a perspective view from inside of the image forming apparatus according to the first embodiment.

FIG. 3B is a perspective view from outside of the image forming apparatus according to the first embodiment.

FIG. 4 is a sectional view of a vicinity of a drive portion and a drive transmitting portion of a process cartridge according to the first embodiment.

FIG. 5A is a perspective view of a pre-drum input gear according to the first embodiment.

FIG. 5B is a perspective view of a drum input gear according to the first embodiment.

FIG. 6A is a perspective view of the drum input gear and a spacer according to the first embodiment.

FIG. 6B is a perspective view of the drum input gear and a spacer according to the first embodiment.

FIG. 7 is a sectional view of the drum input gear and the spacer according to the first embodiment.

FIGS. 8A to 8F are sectional views of a process of mounting the spacer to the drum input gear according to the first embodiment.

### DESCRIPTION OF THE EMBODIMENTS

Hereinafter, an image forming apparatus according to the present disclosure will be described in detail with reference to the drawings. However, it is to be understood that dimensions, materials, shapes, relative arrangements, and the like of components described in the following embodiment are intended to be changed as deemed appropriate in accordance with configurations and various conditions of apparatuses to which the present disclosure is to be applied and are not intended to limit the scope of the present disclosure to the embodiment described below.

In the following description, a direction in which a transport direction of a recording medium in the image forming apparatus is projected onto a horizontal plane is the X direction, a direction parallel to a rotation axis of a photosensitive drum when a process cartridge is mounted to the image forming apparatus is the Y direction, and an upward direction of gravitational force is the Z direction.

### First Embodiment

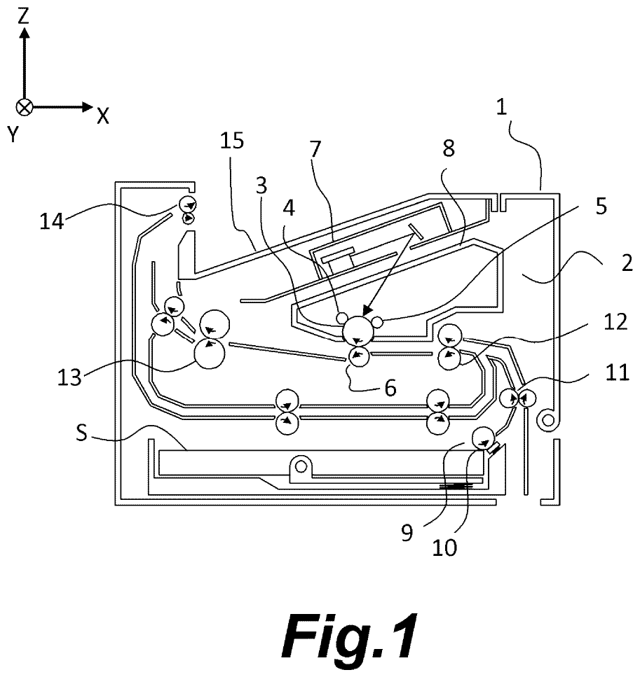

FIG. 1 is a schematic sectional view of an image forming apparatus 1 according to a first embodiment of the present disclosure. The image forming apparatus 1 according to the first embodiment is a monochrome laser beam printer capable of forming monochrome images using an electrophotographic system.

The image forming apparatus 1 is equipped with a drum-type electrophotographic photosensitive member (hereinafter, referred to as a photosensitive drum 3) as an image bearing member. The photosensitive drum 3 is constituted of a photosensitive agent material such as an OPC (organic photo semiconductor), amorphous selenium, or amorphous silicon provided on a cylindrical drum substrate made of aluminum, nickel, or the like. The photosensitive drum 3 is rotatably supported by the image forming apparatus 1 and is rotationally driven at a predetermined speed by a driving source. A charging member 4, a developing member 5, and a transfer roller 6 being a transferring member are arranged in this order around the photosensitive drum 3 along a rotation direction thereof. In addition, a scanner unit 7 that is exposing means is arranged above the photosensitive drum 3. The photosensitive drum 3, the charging member 4, and the developing member 5 constitute a process cartridge 8 that can be integrally attached to and detached from the image forming apparatus 1. A portion of the image forming apparatus 1 excluding the process cartridge 8 can be called an apparatus main body of the image forming apparatus 1.

The image forming apparatus 1 is sequentially equipped with, along a transport path of a recording material S (a recording medium or paper), a cassette paper feeding portion 9 for loading the recording material S such as paper, a paper feeding roller 10, a transport roller 11, a resist roller 12, fixing means 13, a discharge roller 14, and a paper discharge tray 15.

An operation of the image forming apparatus 1 will now be described. The photosensitive drum 3 rotationally driven by the driving source is uniformly charged to a predetermined polarity and a predetermined potential by the charging member 4.

After the photosensitive drum 3 is charged, the scanner unit 7 performs image exposure based on image information on a surface of the photosensitive drum 3, charge is removed from the exposed portion, and an electrostatic latent image is formed. The electrostatic latent image is developed by the developing member 5 and visualized as a toner image. The toner image on the photosensitive drum 3 is transferred to the recording material S by the transfer roller 6.

The recording material S is fed in the X direction by the paper feeding roller 10 from the cassette paper feeding portion 9 in which the recording material S is stacked and stored. The recording material S is transported to a transfer nip portion via the transport roller 11 and the resist roller 12. The toner image transferred from the photosensitive drum 3 to the recording material S at the transfer nip portion is heated and fixed by the fixing means 13. The recording material S having passed through the fixing means 13 is discharged in the X direction onto the paper discharge tray 15 via the discharge roller 14.

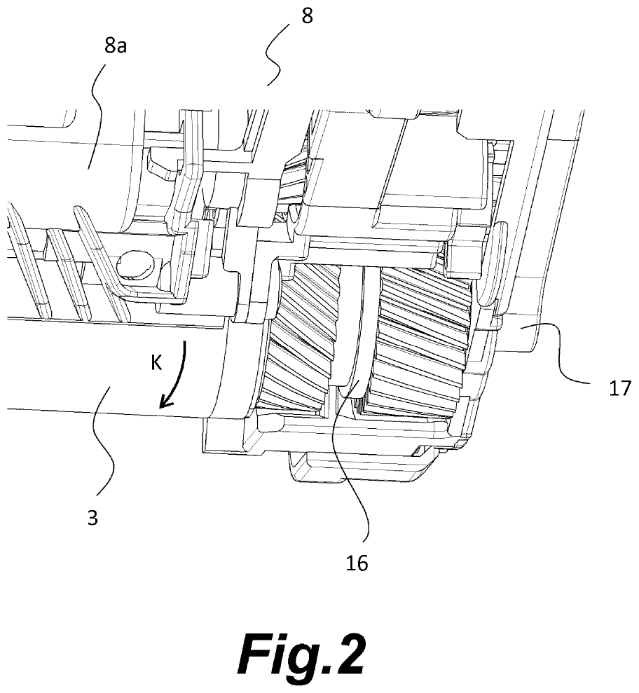

Next, the photosensitive drum drive portion of the process cartridge 8 will be described. FIG. 2 is a perspective view of a drum gear 16 on a drive side of the photosensitive drum 3.

As shown in FIG. 2, the drum gear 16 is coaxially arranged to a rotational axis at a drive-side end portion of the photosensitive drum 3 in an axial direction and the photosensitive drum 3 and the drum gear 16 are coupled to each other so as to be integrally rotatable. The photosensitive drum 3 and the drum gear 16 are rotatably supported by a side cover 17 and a cartridge frame body 8a and rotate in a direction of an arrow K (clockwise in FIG. 1) during image formation.

Next, a drive portion 20 of the image forming apparatus 1 will be described.

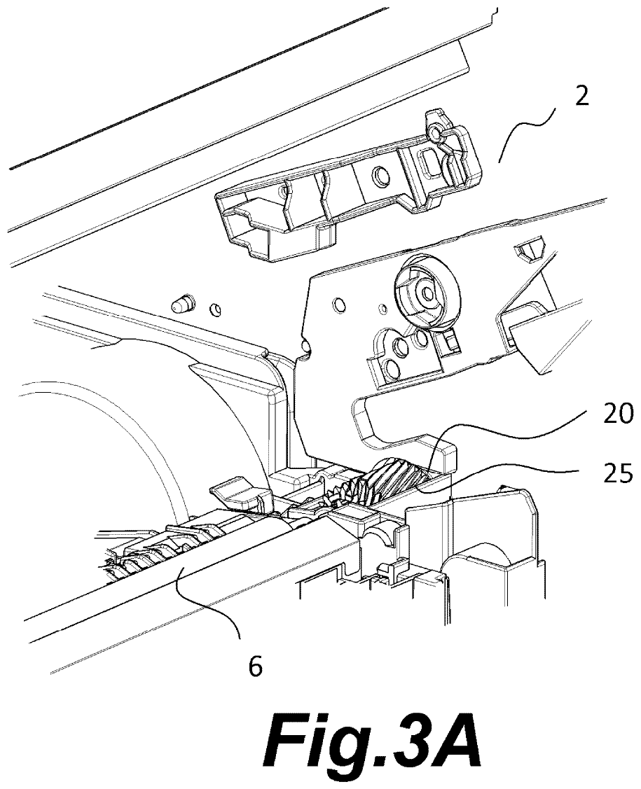

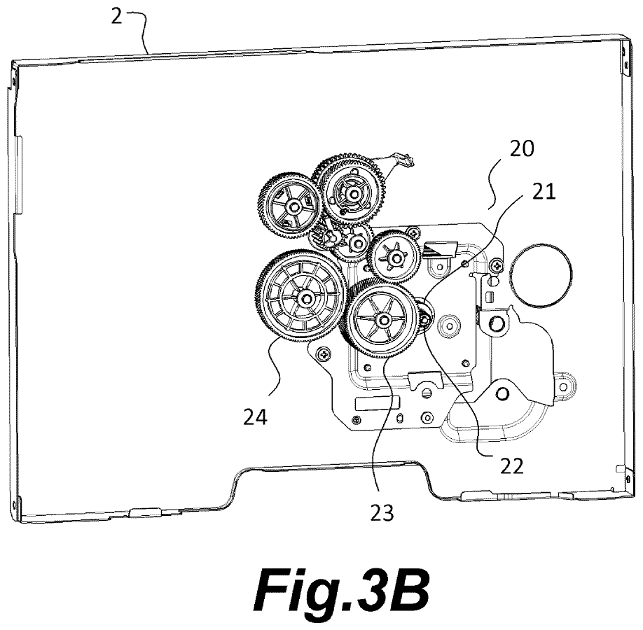

FIGS. 3A and 3B are perspective views of the image forming apparatus 1, in which FIG. 3A shows the image forming apparatus 1 as viewed from inside and FIG. 3B shows the image forming apparatus 1 as viewed from outside.

As shown in FIGS. 3A and 3B, the image forming apparatus 1 includes a gear train of the drive portion 20 that drives the drum gear 16 of the process cartridge 8. The gear train is a helical gear train that transmits a driving force from a pinion gear 22 provided in a drive motor 21 that is a driving source to a pre-drum input gear 24 and a drum input gear 25 via a branch gear 23. The drum input gear 25 is a first gear that is rotatable under the driving force from the drive motor 21. The drum input gear 25 transmits the driving force to the drum gear 16 provided in the process cartridge 8 to rotate the photosensitive drum 3. The drum gear 16 is a second gear (driven gear) which meshes with the drum input gear 25 being the first gear (drive gear) and which is rotatable under the driving force transmitted from the drum input gear 25. The photosensitive drum 3 is a driven member that is driven by the driving force transmitted to the drum gear 16 being the second gear. The photosensitive drum 3 of the process cartridge 8 can be driven and stopped in conjunction with driving and stopping of the drive motor 21 that is the driving source.

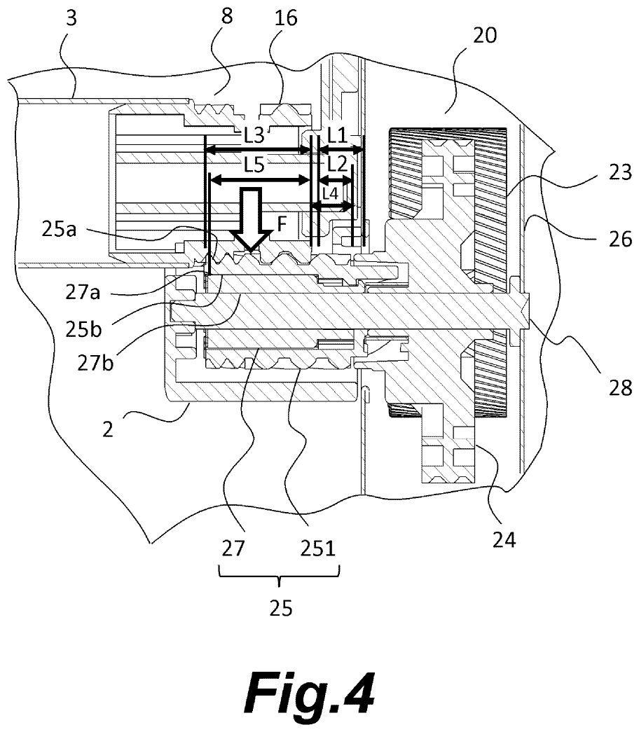

While a drive side plate 26 (refer to FIG. 4) is not illustrated in FIG. 3B so that the drive portion 20 can be readily described, the drive side plate 26 is provided so as to cover the gear train. In addition, drive transmission is also performed from the pinion gear 22 to the resist roller 12 and the fixing means 13 using other gear trains (not illustrated).

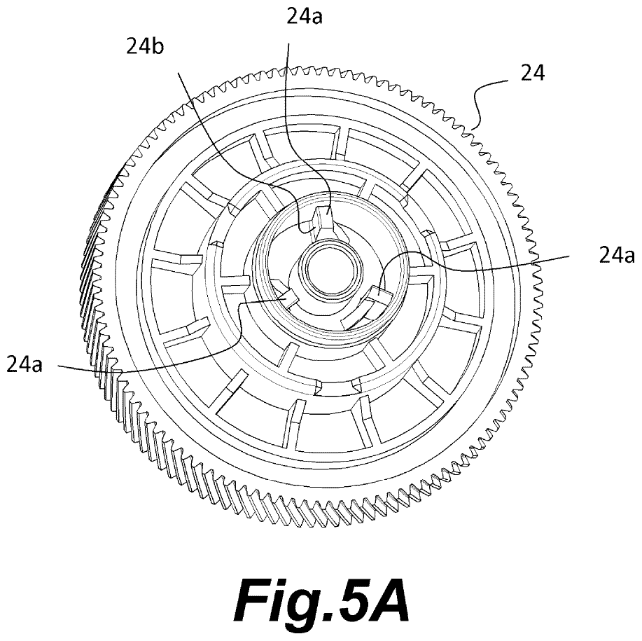

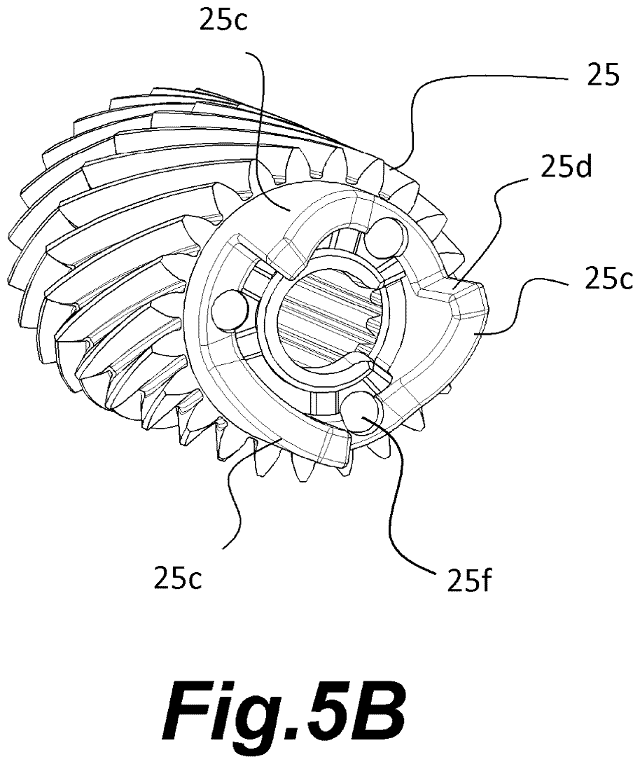

Next, the pre-drum input gear 24 and the drum input gear 25 of the drive portion 20 will be described. FIG. 4 is a sectional view of the drive portion 20 and the process cartridge 8 of the image forming apparatus 1. FIGS. 5A and 5B are perspective views of an engaging portion of the pre-drum input gear 24 and the drum input gear 25, in which FIG. 5A shows the pre-drum input gear 24 as viewed from inside the image forming apparatus 1 and FIG. 5B shows the drum input gear 25 as viewed from outside the image forming apparatus 1.

A shaft member 28 rotatably supports the pre-drum input gear 24 and the drum input gear 25 being the first gear. The shaft member 28 is fixed to the drive side plate 26 so as to prevent the shaft member 28 from moving relative to the drive side plate 26. Due to the drum input gear 25 being supported by the shaft member 28, the drum input gear 25 can rotate around a rotational axis that extends parallel to an axial direction of the shaft member 28. In other words, a direction (rotational axis direction) in which the rotational axis of the drum input gear 25 extends is parallel to an axial direction of the shaft member 28. The pre-drum input gear 24 and the drum input gear 25 are supported by the shaft member 28 with a shaft center of the shaft member 28 as the rotational axis so as to be coaxially rotatable and movable with respect to the axial direction. The shaft member 28 is provided with one end portion fixed to the drive side plate 26 and another end portion supported by a hole of a main body frame 2 so as to be parallel to the rotational axis of the photosensitive drum 3 in a state where the process cartridge 8 is mounted to the image forming apparatus 1.

The drum input gear 25 includes a gear member 251 that is a first member and a spacer 27 that is a second member. The gear member 251 has a cylindrical shape that is coaxial to the shaft member 28. The spacer 27 has a cylindrical shape that is coaxial to the shaft member 28 and is provided in a hole portion 25b that constitutes an interior of the cylindrical shape of the gear member 251. In other words, the spacer 27 is arranged inside (inner side of) the gear member 251 with respect to an orthogonal direction that is perpendicular to the direction of the rotational axis of the drum input gear 25 (axial direction of the shaft member 28). In addition, the spacer 27 can be described as being positioned between the gear member 251 and the shaft member 28 with respect to the orthogonal direction.

The gear member 251 is provided with teeth (gear teeth) 25a on its outer circumferential side that mesh with the teeth of the drum gear 16 being the second gear.

The spacer 27 includes, on an outer circumferential side thereof, a rib 27a that is a contact portion to come into contact with an inner circumferential surface of the hole portion 25b of the gear member 251. In addition, the spacer 27 is rotatably supported by the shaft member 28 by having an inner circumferential surface of a shaft hole 27b that is an interior of a cylindrical shape of the spacer 27 slidably come into contact with an outer circumferential surface of the shaft member 28. In other words, the spacer 27 and the gear member 251 can rotate around the rotational axis relative to the shaft member 28. The rotational axis of the drum input gear 25 can also be described as the rotational axis of the spacer 27 and the gear member 251.

The drum input gear 25 receives a radial load F as a reaction force when transmitting the driving force to the drum gear 16 of the process cartridge 8. The radial load F is supported by the shaft member 28 from the teeth 25a of the drum input gear 25 via the hole portion 25b provided in the drum input gear 25 and the rib 27a and the shaft hole 27b of the spacer 27. In the gear member 251, an area where the teeth of the drum gear 16 and the teeth 25a mesh is called a meshing area. When a range in the axial direction of the meshing area is a third range L3, then the radial load F is to be received by a portion in the third range L3 of the drum input gear 25. The third range L3 can also be described as a range of a portion that meshes with the drum gear 16 among the teeth 25a. In the first embodiment, since the hole portion 25b, the rib 27a, and the shaft hole 27b are in the third range L3, the drum input gear 25 can be supported by the shaft member 28 in a stable state.

The engaging portion of the pre-drum input gear 24 and the drum input gear 25 will be described with reference to FIGS. 5A and 5B.

As shown in FIG. 5A, the pre-drum input gear 24 includes an engaging portion 24a including a plurality of pawls (three in the first embodiment) at an end portion opposing the drum input gear 25. In addition, the engaging portion 24a includes a contact surface 24b that is parallel to the axial direction (perpendicular to the circumferential direction).

As shown in FIG. 5B, the drum input gear 25 includes an engaged portion 25c including a plurality of pawls (three in the first embodiment) that engages with the engaging portion 24a of the pre-drum input gear 24 at an end portion opposing the pre-drum input gear 24. In addition, the engaged portion 25c includes a contact surface 25d that is parallel to the axial direction (perpendicular to the circumferential direction).

By causing the contact surface 24b of the pre-drum input gear 24 and the contact surface 25d of the drum input gear 25 to oppose each other in the circumferential direction and come into contact with each other, the engaging portion 24a and the engaged portion 25c engage and enable the pre-drum input gear 24 and the drum input gear 25 to integrally rotate. Accordingly, a driving force input to the pre-drum input gear 24 from the driving source can be transmitted to the drum input gear 25.

A gate 25f corresponding to an inflow position of a resin material during injection molding is provided in plurality (three in the first embodiment) between the plurality of engaged portions 25c in the circumferential direction. The presence of the plurality of gates 25f enables resin to flow better and improves gear accuracy in the drum input gear 25.

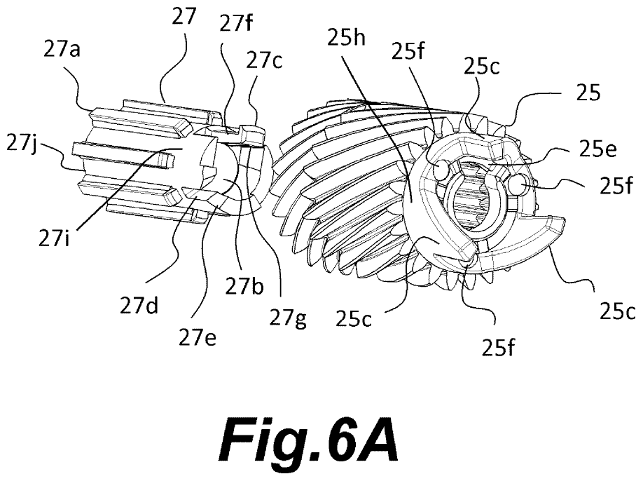

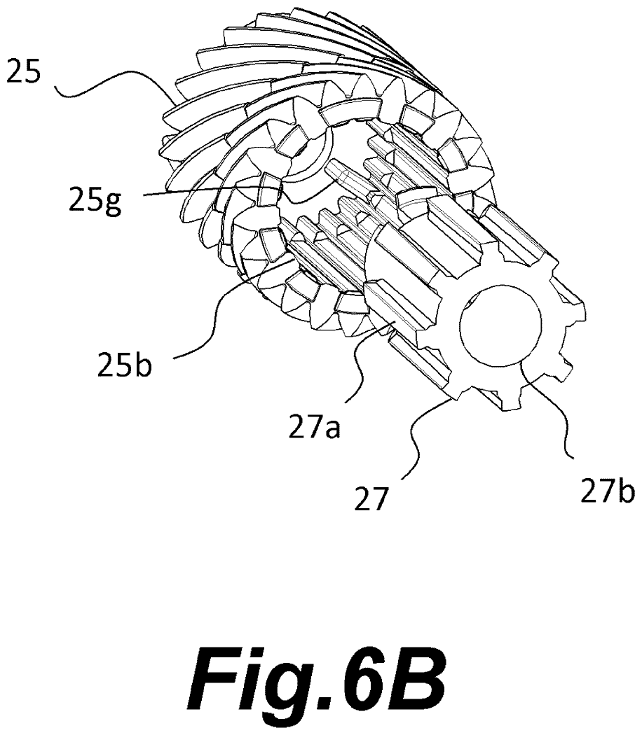

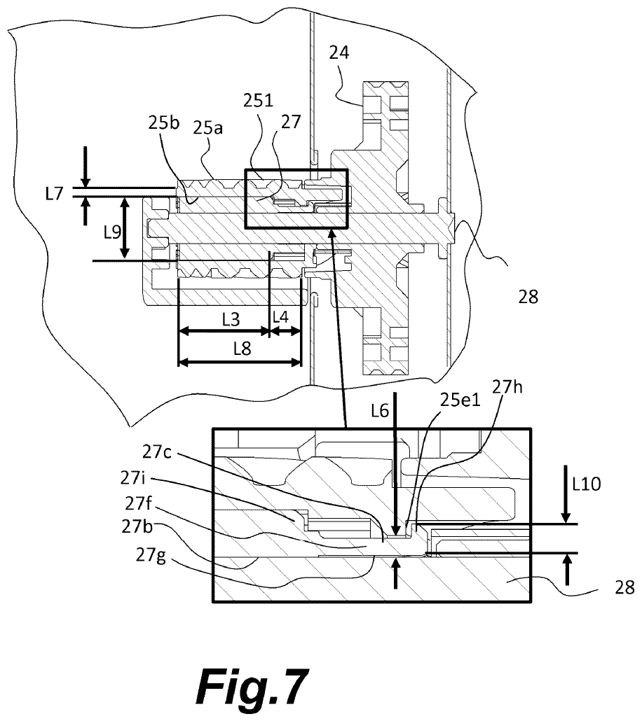

Next, the drum input gear 25 and the spacer 27 will be described. FIGS. 6A and 6B are perspective views of the drum input gear 25 and the spacer 27. FIG. 7 is a sectional view of the drum input gear 25 and the spacer 27.

### Retaining Structure

The drum input gear 25 has a retaining structure being a first restricting structure that restricts relative movement of the spacer 27 in the axial direction of the shaft member 28 relative to the gear member 251. In the first embodiment, the retaining structure includes a first engaging portion 25e provided on the gear member 251 and a snap-fit 27c being a first engaged portion which is provided on the spacer 27 and which is configured to be engaged with the first engaging portion 25e. The first engaging portion 25e has a contact surface that extends in a direction intersecting the axial direction (preferably, orthogonal to the axial direction) and the snap-fit 27c comes into contact with the contact surface.

The first engaging portion 25e includes a first projected portion 25e1 that protrudes radially inward from the inner circumferential surface of the hole portion 25b of the gear member 251.

The snap-fit 27c includes a deflected portion 27f and a pawl 27h. The deflected portion 27f is an arm portion which extends in the axial direction from an end portion 27i on one side in the axial direction of the spacer 27 (a right end portion in FIG. 7: an end portion on a side close to the engagement structure of the drum input gear 25 and the pre-drum input gear 24) and which can deflect in the radial direction. The pawl 27h protrudes radially outward from an end portion on one side in the axial direction of the deflected portion 27f.

In FIG. 7, the pawl 27h and the end portion 27i of the spacer 27 are positioned on opposite sides in the axial direction via the first projected portion 25e1. In this state, by causing a surface perpendicular to the axial direction of the pawl 27h and a surface perpendicular to the axial direction of the first projected portion 25e1 to oppose each other, the first engaging portion 25e and the snap-fit 27c engage with each other.

### Rotation-Preventing Structure

In addition, the drum input gear 25 has a rotation-preventing structure being a second restricting structure that restricts relative movement of the spacer 27 in the circumferential direction of the shaft member 28 relative to the gear member 251. In the first embodiment, the rotation-preventing structure includes a second projected portion 25g being a second engaging portion provided on the gear member 251 and a slit 27d being a second engaged portion which is provided on the spacer 27 and which is configured to be engaged with the second projected portion 25g.

The second projected portion 25g protrudes radially inward from the inner circumferential surface of the hole portion 25b of the drum input gear 25. The second projected portion 25g is provided at an end portion 25h on one side in the axial direction of the hole portion 25b of the drum input gear 25.

The slit 27d is a slit that extends in the axial direction from an end portion 27i of the spacer 27 on a same side as the end portion 25h of the gear member 251, on which the second projected portion 25g is provided, toward the opposite side of the end portion 27j. A catching shape 27e is provided at an inlet of the slit 27d.

By inserting the second projected portion 25g into the slit 27d and positioning a surface perpendicular to the circumferential direction included in the second projected portion 25g and a surface perpendicular to the circumferential direction included in the slit 27d at positions where the surfaces oppose each other, the second projected portion 25g and the slit 27d engage with each other.

### Ribs of Spacer

The outer circumferential surface side of the spacer 27 is provided with a plurality of ribs 27a that are a plurality of protruded portions provided on an the outer circumferential surface of the cylindrical shape of the spacer 27 as contact portions that come into contact with the inner circumferential surface of the hole portion 25b of the gear member 251 of the drum input gear 25. The plurality of ribs 27a each extend in the axial direction and are provided spaced in the circumferential direction. By bringing apexes of the ribs 27a and the inner circumferential surface of the hole portion 25b of the gear member 251 into contact with each other, the shaft member 28 supports the gear member 251 via the spacer 27.

### Thickness of Gear Member

As shown in FIG. 7, a thickness in the radial direction of the gear member 251 of the drum input gear 25 is L7. The thickness L7 is a length in the radial direction between the inner circumferential surface of the hole portion 25b of the gear member 251 and the outer circumferential surface of the cylindrical shape of the gear member 251 (root circle of the teeth 25a). The gear member 251 is a molded component created by injection molding and the thickness L7 is set so as to ensure fluidity and component strength in injection molding and to prevent sink marks due to shrinkage after molding. Generally, when POM (polyacetal) is used as a resin material for molding components that require sliding ability such as gears, the thickness L7 is suitably set to around 1 to 2 mm.

When the thickness L7 is thinner than the suitable value, it may be difficult to ensure fluidity of the resin material during molding and component strength may decline. On the other hand, when the thickness L7 is thicker than the suitable value, sink marks due to shrinkage after molding may occur and molding accuracy of gears may decline.

Now, as a comparison with the first embodiment, consider a case where the drum input gear 25 is not configured to be made up of two members, namely, the gear member 251 and the spacer 27 but is solely constituted of the gear member 251. In this case, the shaft member 28 directly supports the gear member 251 and the inner circumferential surface of the gear member 251 and the outer circumferential surface of the shaft member 28 slide against each other. In this configuration, in order to make the outer diameter and the thickness L7 of the gear member 251 the same as in the first embodiment, the outer diameter of the shaft member 28 must be increased to a diameter corresponding to the inner diameter of the hole portion 25b of the gear member 251. In this case, a peripheral velocity of the sliding surface of the hole portion 25b and the shaft member 28 increases and an amount of abrasion due to sliding also increases. In addition, when a metal is to be used as the material of the shaft member 28, since the shaft member 28 is a member with a large diameter, a necessary amount of metallic material increases and cost rises. Furthermore, in order to make the outer diameter of the gear member 251 and the diameter of the shaft member 28 the same as in the first embodiment, since the thickness L7 of the gear member 251 becomes thicker than the suitable value, a thinned shape must be provided order to prevent a decline in molding accuracy due to sink marks. In this case, there is a possibility that strength and support rigidity of the gear member 251 declines. In addition, in order to make the thickness L7 of the gear member 251 and the diameter of the shaft member 28 the same as in the first embodiment, since the outer diameter of the gear member 251 must be reduced, the number of teeth of the drum input gear 25 decreases. In this case, since a reduction ratio at the drum input gear 25 and the drum gear 16 increases, it becomes necessary to adopt a tooth count that reduces a reduction ratio in the gears upstream of the drive train. As a result, a peripheral velocity of a flank of the gears upstream of the drive train increases and operation noise during image formation becomes louder.

On the other hand, in the first embodiment, since the drum input gear 25 is constituted by two members, namely, the gear member 251 on which gear teeth are formed and the spacer 27 supported by the shaft member 28, a decline in accuracy due to sink marks during injection molding of the gear member 251 and declines in strength and support rigidity can be both suppressed.

Next, the retaining structure and the rotation-preventing structure of the gear member 251 and the spacer 27 in the drum input gear 25 will be described in detail.

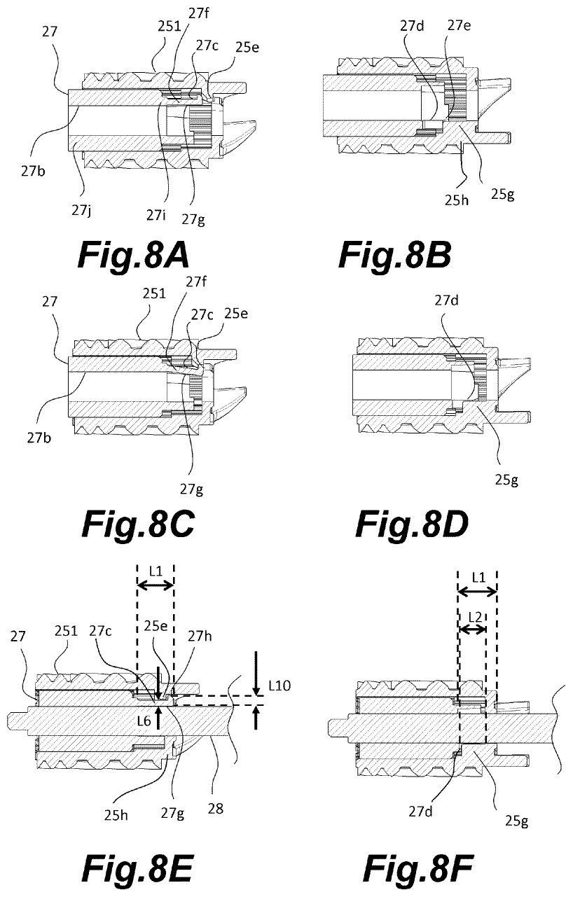

FIGS. 8A to 8F are sectional views schematically showing a process of mounting the spacer 27 to the gear member 251, in which FIGS. 8A, 8C, and 8E are sectional views at positions in the circumferential direction including the first engaging portion 25e of the gear member 251 and the snap-fit 27c of the spacer 27. FIGS. 8B, 8D, and 8F are sectional views at positions in the circumferential direction including the second projected portion 25g of the gear member 251 and the slit 27d of the spacer 27. The slit 27d is positioned so as not to overlap with a 180-degree position of the snap-fit 27c with respect to the circumferential direction of the spacer 27 (rotation direction of the drum input gear 25) that is centered on the rotational axis of the drum input gear 25. In other words, an angle formed by one end of the slit 27d and one end of the snap-fit 27c differs from an angle formed by another end of the slit 27d and another end of the snap-fit 27c with respect to the circumferential direction of the spacer 27 (rotation direction of the drum input gear 25) that is centered on the rotational axis of the drum input gear 25. Therefore, with respect to a direction perpendicular to the rotational axis of the drum input gear 25, a straight line passing through the rotational axis of the drum input gear 25 and the snap-fit 27c does not overlap with the slit 27d. In addition, one of the angle formed by one end of the slit 27d and one end of the snap-fit 27c and the angle formed by another end of the slit 27d and another end of the snap-fit 27c is larger than 180 degrees.

FIGS. 8A and 8B are diagrams showing a situation before the snap-fit 27c deflects in the process of mounting the spacer 27 to the gear member 251. FIGS. 8C and 8D are diagrams showing a situation during deflection of the snap-fit 27c. FIGS. 8E and 8F are diagrams showing a situation where, after mounting the spacer 27 to the gear member 251, the drum input gear 25 is mounted to the shaft member 28.

### Operation of Retaining Structure

As shown in FIGS. 8A to 8D, the spacer 27 is mounted to the gear member 251 along a predetermined insertion direction. In the mounting process, the snap-fit 27c deflects as shown in FIGS. 8C and 8D. In addition, as shown in FIGS. 8E and 8F, once the spacer 27 is mounted until abutting against the end portion 25h of the gear member 251, the deflection of the snap-fit 27c is eliminated and the snap-fit 27c engages with the first engaging portion 25e of the gear member 251. Accordingly, relative movement of the gear member 251 and the spacer 27 is restricted in the insertion direction of the spacer 27 relative to the gear member 251. The insertion direction of the spacer 27 relative to the gear member 251 is parallel to the rotational axis direction of the drum input gear 25. Furthermore, in a state where the drum input gear 25 has been attached to the shaft member 28, the insertion direction of the spacer 27 relative to the gear member 251 is parallel to the axial direction of the shaft member 28.

The deflected portion 27f of the snap-fit 27c includes an opposing surface 27g that opposes the outer circumferential surface of the shaft member 28 as shown in FIG. 7. A radial load F that is received by the drum input gear 25 when driving the drum gear 16 is received by the shaft member 28 via the shaft hole 27b of the spacer 27. Therefore, there is no need for the opposing surface 27g of the snap-fit 27c to receive the radial load F. Accordingly, since the snap-fit 27c does not receive the radial load F even when the drum input gear 25 rotates, the shaft member 28 can support the drum input gear 25 in a stable manner.

As shown in FIG. 7 and FIGS. 8E and 8F, a length in the radial direction from the opposing surface 27g to a radially outward end portion of the pawl 27h of the snap-fit 27c is L10 (referred to as a snap-fit pawl height). In addition, a distance (gap) between the outer circumferential surface of the shaft member 28 and a radially inward end portion of the first projected portion 25e1 of the first engaging portion 25e of the gear member 251 is L6. The snap-fit pawl height L10 is greater than the gap L6. In a state where the drum input gear 25 is mounted to the shaft member 28, the snap-fit 27c comes into contact with the shaft member 28 when moving the snap-fit 27c so that the engagement of the snap-fit 27c and the first engaging portion 25e is released. Accordingly, as shown in FIGS. 8E and 8F, by mounting the drum input gear 25 to the shaft member 28 after mounting the spacer 27 to the gear member 251, the spacer 27 is prevented from detaching from the gear member 251. In other words, in a state where the drum input gear 25 is mounted to the shaft member 28, disengagement of the snap-fit 27c and the first engaging portion 25e is restricted by the shaft member 28.

### Operation of Rotation-Preventing Structure

As shown in FIGS. 6A and 6B and FIGS. 8A to 8D, the spacer 27 includes the slit 27d and the catching shape 27e at the inlet of the slit 27d. As shown in FIGS. 8A and 8B, the second projected portion 25g of the gear member 251 is caught by the catching shape 27e and the slit 27d starts engagement with the second projected portion 25g. Due to the engagement of the slit 27d with the second projected portion 25g, a phase in the circumferential direction of the gear member 251 and the spacer 27 is determined.

At this point, the snap-fit 27c has not deflected yet. In other words, in the process of mounting the spacer 27 to the gear member 251, the slit 27d engages with the second projected portion 25g before the snap-fit 27c engages with the first engaging portion 25e. That is, in the process of mounting the spacer 27 to the gear member 251, after a phase in the circumferential direction is determined, the snap-fit 27c deflects and engages with the first engaging portion 25e. Therefore, in the mounting process, the snap-fit 27c can be guided in a correct phase relative to the first engaging portion 25e.

Due to the engagement of the slit 27d with the second projected portion 25g, relative movement of the gear member 251 and the spacer 27 in the circumferential direction is restricted and rotation prevention can be achieved. Accordingly, sliding of the spacer 27 and the gear member 251 can be suppressed when being driven while facilitating sliding of the spacer 27 and the shaft member 28. In addition, when assembling the drum input gear 25, since the spacer 27 and the gear member 251 is always in the same phase in the circumferential direction, accuracy of the gear can be readily improved by fine-tuning shapes of the hole portion 25b and the rib 27a.

As shown in FIGS. 4, 6A, 6B, 8E, and 8F, in the gear member 251, a range in the axial direction of a portion provided with the first restricting structure (the retaining structure due to the first engaging portion 25e and the snap-fit 27c) is a first range L1. In addition, in the gear member 251, a range in the axial direction of a portion provided with the second restricting structure (the rotation-preventing structure due to the second projected portion 25g and the slit 27d) is a second range L2. In this case, in the first embodiment, the first range L1 and the second range L2 at least partially overlap with each other in the axial direction of the shaft member 28. Accordingly, a configuration equipped with both a retaining structure and a rotation-preventing structure can be realized in a compact manner.

In addition, as shown in FIG. 4, In the gear member 251, a range of the meshing area where the teeth of the drum gear 16 and the teeth 25a mesh is a third range L3. In this case, with respect to the axial direction, a position where the first engaging portion 25e and the snap-fit 27c engage does not overlap with the third range L3. Furthermore, with respect to the axial direction, a position where the second projected portion 25g and the slit 27d engage does not overlap with the third range L3. In the present embodiment, the first range L1 and the third range L3 do not overlap and, at the same time, the second range L2 and the third range L3 do not overlap. That is, the retaining structure and the rotation-preventing structure are provided in a portion other than the third range L3 in the drum input gear 25. In the drum input gear 25, a structure of the portion provided with the retaining structure and the rotation-preventing structure is not uniform in the circumferential direction. Therefore, when adopting a configuration in which teeth of the drum input gear 25 and teeth of the drum gear 16 mesh in the portion provided with the retaining structure and the rotation-preventing structure, gear accuracy may decline. In the configuration according to the first embodiment, since the meshing portion of the drum input gear 25 and the drum gear 16 is not provided in a portion where the structure in the circumferential direction is not uniform in the drum input gear 25, a decline in gear accuracy can be suppressed.

In addition, as shown in FIGS. 4 and 7, the gear member 251 is also provided with teeth 25a in a fourth range L4 that continues in the axial direction from the third range L3. In other words, in the axial direction of the shaft member 28, the teeth 25a of the drum input gear 25 are formed in a range L8 which includes the third range L3 but is longer than the third range L3. The teeth 25a are also formed so as to continue from the third range L3 in the fourth range L4 which extends from an end portion in the axial direction of the third range L3 to the engagement portion between the drum input gear 25 and the pre-drum input gear 24 where the engaged portion 25c is provided. Accordingly, rigidity of the drum input gear 25 is improved.

Appropriately determining the length in the axial direction of the third range L3 enables meshing between the teeth of the drum gear 16 and the teeth 25a of the drum input gear 25 to be secured and drive transmission error between the drum gear 16 and the drum input gear 25 to be reduced. In addition, by distributing a load during transmission of a driving force, a service life of the drum input gear 25 can be prolonged.

The length in the axial direction of the third range L3 is longer than an inner diameter of the cylindrical shape of the gear member 251 (an inner diameter L9 of the hole portion 25b). Accordingly, the drum input gear 25 can be supported by the shaft member 28 in a stabler state.

As shown in FIG. 4, in the drum input gear 25, when a range in the axial direction of a portion where the inner circumferential surface of the hole portion 25b of the gear member 251 and the rib 27a of the spacer 27 come into contact with each other is a fifth range L5, the fifth range L5 includes the third range L3.

As shown in FIGS. 6A and 6B, the position in the circumferential direction of the retaining structure (the first engaging portion 25e and the snap-fit 27c) overlaps with the position in the circumferential direction of one rib 27a among the plurality of ribs 27a of the spacer 27. In addition, the position in the circumferential direction of the rotation-preventing structure (the second projected portion 25g and the slit 27d) overlaps with the position in the circumferential direction of one rib 27a among the plurality of ribs 27a of the spacer 27. The rib 27a of which the position in the circumferential direction overlaps with the retaining structure and the rib 27a of which the position in the circumferential direction overlaps with the rotation-preventing structure differ from each other. Accordingly, in the spacer 27, any number of ribs 27a optimal for component accuracy can be provided regardless of shapes of the snap-fit 27c and the slit 27d.

As described above, in the first embodiment, the gear member 251 and the spacer 27 that constitute the drum input gear 25 are provided with the retaining structure made up of the first engaging portion 25e and the snap-fit 27c and the rotation-preventing structure made up of the second projected portion 25g and the slit 27d. Accordingly, even when subjected to vibration during driving or ambient temperature changes, the gear member 251 and the spacer 27 can be prevented from sliding and the spacer 27 can be prevented from falling out of the gear member 251.

In addition, by configuring the retaining structure using the snap-fit 27c and the rotation-preventing structure as separate structures, there is no need to prevent rotation using the snap-fit 27c that readily deflects. Therefore, there is no need to provide the snap-fit 27c in plurality in order to secure enough strength to prevent rotation. Accordingly, a retaining structure and a rotation-preventing structure can be realized with a compact configuration.

As a comparison to the first embodiment, it is conceivable to configure the retaining structure and the rotation-preventing structure by increasing the amount by which the spacer 27 is press-fitted into the gear member 251. However, with this configuration, increasing the press-fit amount may cause the flank of the drum input gear 25 to deform. The configuration of the first embodiment can suppress occurrences of such flank deformation. In addition, as a comparison to the first embodiment, it is conceivable to configure the retaining structure and the rotation-preventing structure by gluing the gear member 251 and the spacer 27 to each other.

However, the resin material POM used for sliding components is a hardly-adhesive material and is difficult to fix with inexpensive adhesives. Furthermore, as a comparison to the first embodiment, it is conceivable to ultrasonically weld the gear member 251 and spacer 27 to each other. However, when there are a large number of contact portions between the inner circumferential surface of the gear member 251 and the outer circumferential surface of the spacer 27 such as the plurality of ribs 27a, a welding range cannot be clearly defined, and welding is difficult.

In addition, in the first embodiment, a configuration is adopted in which the drum input gear 25 is constituted of two materials, namely, the gear member 251 and the spacer 27, and the shaft member 28 supports the spacer 27. Accordingly, a component provided with teeth that mesh with the drum gear 16 and a component supported by the shaft member 28 can be constituted as different components. Therefore, since sink marks during injection molding can be suppressed even when a diameter of the drum input gear 25 is relatively large, a decline in gear accuracy attributable to sink marks can be suppressed. In addition, since there is no need to provide a thinned structure, a decline in gear strength and a decline in support rigidity can be suppressed.

Furthermore, when the drum input gear 25 is mounted to the shaft member 28 after mounting the spacer 27 to the gear member 251, since the snap-fit pawl height L10 is greater than the gap L6, the spacer 27 can be prevented from detaching from the gear member 251.

In addition, due to the engagement of the slit 27d with the second projected portion 25g, rotation of the gear member 251 and the spacer 27 can be prevented and sliding of the gear member 251 and the spacer 27 during driving can be suppressed. Accordingly, sliding can be made to more reliably occur between the spacer 27 and the shaft member 28.

In addition, in the spacer 27, the deflected portion 27f of the snap-fit 27c constituting the retaining structure and the slit 27d constituting the rotation-preventing structure are provided so that positions in the axial direction of the shaft member 28 overlap with each other. Accordingly, a configuration including both the retaining structure and the rotation-preventing structure can be realized in a compact manner.

Furthermore, in the drum input gear 25, the snap-fit 27c constituting the retaining structure and the slit 27d constituting the rotation-preventing structure are provided outside of the third range L3. Accordingly, since the teeth 25a that mesh with the teeth of the drum gear 16 are provided in a portion in which a shape in the circumferential direction is uniform in the drum input gear 25, a decline in gear accuracy can be suppressed.

According to the first embodiment, when a gear that transmits a driving force to a driven member of an image forming apparatus is constituted of two members, the relative movement of the two members can be suppressed with a compact structure and a decline in the accuracy of the gear can be suppressed. Accordingly, a compact high-accuracy gear can be constructed and an image forming apparatus capable of producing images with high image quality can be provided without increasing apparatus size.

While the present disclosure has been described in terms of a specific embodiment, the present disclosure is not limited to the first embodiment. For example, in the first embodiment, a gear included in a gear train that drives the photosensitive drum 3 was explained as an example of a gear that transmits a driving force to a driven member. However, the present disclosure can also be applied to a gear included in a gear train that drives the driven members included in the developing member 5, the resist roller 12, the fixing means 13, and the like. Even in such cases, a high-accuracy gear can be constructed in a compact manner in a similar manner to the first embodiment and effects such as operation noise reduction can be obtained without increasing apparatus size.

While the gears of the gear train have been described using an example of a helical gear, the gears may be spur gears, belt pulleys, and the like as long as drive transmission is possible.

The number of pawls included in the engaging portion 24a of the pre-drum input gear 24 and the engaged portion 25c of the drum input gear 25 is not limited to three as in the first embodiment. Note that the greater the number of pawls, the more load can be distributed, the more the shape deformation of the pawls can be controlled, and the rotational accuracy during drive transmission can be ensured. Shape deformation of the pawls can be suppressed by increasing rigidity of the pawls.

The number of ribs 27a of the spacer 27 is not limited to the eight in the first embodiment as long as the gear member 251 can be supported and can be determined according to sizes or moldability of components.

The first embodiment illustrates a configuration where, by making the snap-fit pawl height L10 of the spacer 27 larger than the gap L6, the spacer 27 is prevented from detaching from the gear member 251 when mounting the drum input gear 25 to the shaft member 28. A configuration of preventing the spacer 27 from detaching from the gear member 251 is not limited thereto and, for example, a structure in which the pawl 27h of the snap-fit 27c and the first engaging portion 25e cut into each other in the axial direction may be provided.

According to the present disclosure, when a gear that transmits a driving force to a driven member of an image forming apparatus is constituted of two members, the relative movement of the two members can be suppressed with a compact structure.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-015859, which was filed on Feb. 5, 2024 and which is hereby incorporated by reference herein in its entirety.

What is claimed is:

1. An image forming apparatus, comprising:
a shaft member;
a first gear configured to receive a driving force from a driving source, the first gear being supported by the shaft member so as to be rotatable around a rotational axis extending in an axial direction of the shaft member;
a second gear configured to mesh with the first gear, the second gear being rotatable by the driving force transmitted from the first gear; and
a driven member that is driven by the driving force transmitted to the second gear,
wherein the first gear includes:
a first member that is provided with gear teeth, the gear teeth of the first member being configured to mesh with teeth of the second gear;
a second member, which is provided inside the first member with respect to a direction orthogonal to the axial direction and which is rotatably supported by the shaft member, and provided with (i) a contact portion that comes into contact with an inner circumferential surface of the first member, (ii) an inner circumferential surface slidably coming into contact with an outer circumferential surface of the shaft member;
a first restricting structure including a first engaging portion and a first engaged portion configured to be engaged with the first engaging portion, the first restricting structure restricting a relative movement, in the axial direction, of the second member relative to the first member; and
a second restricting structure including a second engaging portion and a second engaged portion configured to be engaged with the second engaging portion, the second restricting structure restricting a relative movement, in a circumferential direction of the shaft member, of the second member relative to the first member, and
wherein, in the first gear, a first range and a second range at least partially overlap with each other with respect to the axial direction, where the first range is a range, in the axial direction, of a portion that is provided with the first restricting structure, and the second range is a range, in the axial direction, of a portion that is provided with the second restricting structure.

2. The image forming apparatus according to claim 1, wherein, in the axial direction, a position, where the first engaging portion and the first engaged portion engage with each other, and a third range do not overlap and a position, where the second engaging portion and the second engaged portion engage with each other, and the third range do not overlap, wherein the third range is a range, in the axial direction, of a meshing area in which the gear teeth mesh with the second gear.

3. The image forming apparatus according to claim 2, wherein the first range and the third range do not overlap and the second range and the third range do not overlap.

4. The image forming apparatus according to claim 3, wherein in the first member, teeth are also provided in a fourth range that continues, in the axial direction, from the third range.

5. The image forming apparatus according to claim 2, wherein in the first member, teeth are also provided in a fourth range that continues, in the axial direction, from the third range.

6. The image forming apparatus according to claim 2, wherein a length, in the axial direction, of the third range is greater than an inner diameter of the first member.

7. The image forming apparatus according to claim 2, wherein a fifth range includes the third range, wherein the fifth range is a range, in the axial direction, of a portion where the inner circumferential surface of the first member and the contact portion of the second member come into contact with each other in the first gear.

8. The image forming apparatus according to claim 1, wherein the contact portion of the second member includes a plurality of protruded portions, each of the plurality of protruded portions extending in the axial direction, and the plurality of protruded portions coming into contact with the inner circumferential surface of the first member.

9. The image forming apparatus according to claim 8, wherein in the first gear, each of (i) a position, in the circumferential direction, of the portion provided with the first restricting structure and (ii) a position, in the circumferential direction, of the portion provided with the second restricting structure overlaps with a position, in the circumferential direction, of any of the plurality of protruded portions of the second member.

10. The image forming apparatus according to claim 1,
wherein the first engaging portion is provided in the first member, and
wherein the first engaged portion is provided in the second member.

11. The image forming apparatus according to claim 10,
wherein the first engaging portion includes a first projected portion that protrudes radially inward from the inner circumferential surface of the first member, and
wherein the first engaged portion includes a snap-fit configured to be engaged with the first projected portion.

12. The image forming apparatus according to claim 11,
wherein the snap-fit includes:
an arm portion that extends in the axial direction from an end portion of the second member, the arm portion being configured to deflect in the radial direction; and
a pawl that protrudes radially outward from an end portion of the arm portion, and
wherein the first engaging portion and the first engaged portion engage with each other by the pawl, the end portion of the second member being positioned on opposite sides in the axial direction with respect to the first projected portion, and a surface perpendicular to the axial direction of the pawl and a surface perpendicular to the axial direction of the first projected portion being opposed to each other.

13. The image forming apparatus according to claim 12,
wherein the arm portion includes an opposing surface that opposes the outer circumferential surface of the shaft member, and
wherein a length in the radial direction from the opposing surface to a radially outward end portion of the pawl is greater than a distance in the radial direction between the outer circumferential surface of the shaft member and a radially inward end portion of the first projected portion.

14. The image forming apparatus according to claim 1,
wherein the second engaging portion is provided in the first member, and
wherein the second engaged portion is provided in the second member.

15. The image forming apparatus according to claim 14,
wherein the second engaging portion includes a second projected portion provided at an end portion of the first member, the second projected portion protruding radially inward from the inner circumferential surface of the first member,
wherein the second engaged portion includes a slit that extends in the axial direction from an end portion of the second member on a same side as the end portion of the first member, on which the second projected portion is provided, toward an opposite side end portion, and
wherein the second engaging portion and the second engaged portion engage with each other by inserting the second projected portion into the slit.
